(19) United States
(12) Patent Application Publication
(10) Pub. No.: US 2005/0170141 A1
(43) Pub. Date: Aug. 4, 2005

(54) Roofing materials made with nylon fiber composites

(76) Inventors: Forrest C. Bacon, Conyers, GA (US); Wendell R. Holland, Conyers, GA (US); John Tikalsky, Discovery Bay, CA (US)

Correspondence Address: Patrick D. Kelly, 11939 Manchester #403, St. Louis, MO, 63131, US

(21) Appl. No.: 10/438,036

(22) Filed: May 13, 2003

Related U.S. Application Data
(63) Continuation-in-part of application No. 10/284,598, filed on Oct. 31, 2002.
(60) Provisional application No. 60/379,996, filed on May 13, 2002.

(51) Int. Cl. B32B 3/30

(52) U.S. Cl. 428/141; 428/167

(57) ABSTRACT

Synthetic nylon fiber composite materials having embossed or molded surfaces that emulate shingles or roofing tiles are disclosed, for providing waterproof, high-strength, durable substitute for shingles or roofing tiles. In one embodiment, these materials can be relatively thin, and designed to rest on supporting sheets of plywood, oriented strand board (OSB), or nylon fiber composite board that have been nailed to rafters. In an alternate embodiment, these materials can be manufactured in sheets with sufficient thickness, stiffness, and strength to allow them to be nailed directly to rafters, thereby eliminating the need for a supporting layer of plywood or OSB. In a third embodiment, these materials can be molded or embossed to emulate Spanish tiles, or to provide enhanced drainage or other useful traits. For improved waterproofing, the lower edge of each segment can be provided with an overhang that will overlap the upper edge of an adjacent sheet on the next lower horizontal row, to provide overlapping material at each juncture between these composite segments. These materials also can be coated or embedded with chemicals that provide increased resistance to water, fire, and ultraviolet damage. They provide excellent thermal insulation, and can reduce heating and air conditioning costs. A preferred manufacturing process uses needle-punched fiber mats, and any combination of nylon-6 and nylon-6,6 fibers can be used.

### RELATED APPLICATIONS

This application is a continuation-in-part of U.S. utility application Ser. No. 10/284,598, filed on Oct. 31, 2002, which in turn claimed priority based on Patent Cooperation Treaty application PCT/US01/11895, published as WO 01/76869, which had an international filing date of Apr. 11, 2001.

This application also claims the benefit, under 35 USC 120(e), of provisional patent application No. 60/379,996, filed on May 13, 2002.

### FIELD OF THE INVENTION

This invention is in the field of building materials, and relates to waterproof sheets or segments of materials that can be affixed to the roof of a house or other building, to replace shingles, roofing tiles, and similar materials.

### BACKGROUND OF THE INVENTION

PCT application WO 01/76869 (Bacon et al) describes a process for making, from shredded carpet segments, synthetic materials that can substitute for “sheetwood” products (such as plywood, particle board, “chipboard”, oriented strand board (OSB)). In general, the traits that allow a synthetic material to emulate a sheetwood product include: (i) a desired level of stiffness that is not brittle; (ii) the ability to saw the material into smaller segments; (iii) the ability to drive a nail or a screw through the material without creating a cracked, split, or otherwise weakened hole; and, (iv) thickness and density levels that are comparable to plywood, rather than sheet metal, fiberglass, or similar materials.

Although articles with narrower sizes (comparable to boards, planks, or studs) can also be made from shredded carpet segments, the ability to manufacture wood substitutes in sheet form comparable to plywood can provide benefits and advantages that cannot be achieved by narrower articles that substitute for boards or planks.

The method of manufacturing sheetwood substitutes described in PCT application WO 01/76869 uses, as an intermediate, a type of flexible fibrous mat referred to herein as a needle-punched mat. Needle-punched mats are not the only types of flexible fibrous mats that can be used to make roofing materials as described herein. Other types of fibrous mats (such as “bat-formed” and “air-laid” mats, as two examples) can be made from other processes, and those types of fibrous mats can be used to make various grades of roofing materials, by means of various processes disclosed herein. However, needle-punched mats have better cohesive and tensile strength, due to the higher degree of intertwining within the fibrous matrix created by the needle-punching operation. Therefore, it is believed and anticipated that needle-punched mats can provide roofing materials that will exhibit greater strength and durability, over a span of decades spent under exposed weathering conditions, than similar roofing materials made from bat-formed, air-laid, or similar types of fiber mats. Accordingly, needle-punched mats provide intermediates that are generally preferred for use in manufacturing roofing materials as disclosed herein. Therefore, the discussion below will focus on needle-punching as a preferred method of manufacture, but it should be kept in mind that fibrous mats made by bat-forming, air-laying, or other methods can also be evaluated for use as disclosed herein, and such mats can be used, if desired, to make roofing materials containing nylon fibers.

Manufacture of Needle-Punched Nylon Fiber Mats

Roughly a dozen facilities located in various sites across America currently make needle-punched mats from discarded carpet segments. The steps that are used in most of those facilities to make needle-punched mats can be summarized as follows:

1. Discarded carpet segments are shredded, to create a rough yarn mass. The carpet segments used as feedstock in this process are divided into two main categories: (1) post-industrial waste, which refers to edge trimmings, unsold rolls, and other pieces of carpet that were never installed on a floor and walked on; and, (2) post-consumer carpet, which includes any piece of carpet that was installed on a floor and walked on, before being pulled up and discarded.

2. The rough yarn mass from the shredded carpet segments is pulled open and combed by a needle-cylinder machine, to create an open and fluffy mass of fibers, containing mostly nylon (from the carpet tufts) with some polypropylene (from the carpet backing). Some facilities blend these fibers with other types of fibers, such as fibers made by shredding discarded clothing or other textiles.

3. The mass of fibers is combed in a manner that forms a continuous ribbon, usually about 2 to 4 feet wide. This continuous ribbon is then laid down on a large slow-moving conveyor system, by a machine called a cross-lapper. A cross-lapper machine has a “head” that travels continuously, back and forth, along a set of rails that are mounted transversely above the slow-moving conveyor. As the “head” moves back and forth along its rails, driven by a chain or belt system, it lays down its continuous wide ribbon of combed nylon fibers, on top of the slow-moving conveyor. Instead of being a continuous smooth belt, the conveyor typically is made of parallel wooden slats, to allow debris (such as dirt and latex particles) to fall between the slats and be collected.

In most facilities, the conveyor system is about 13 feet wide, so that after the side edges of a mat are trimmed off by cutting blades, the final mat will be exactly 12 feet wide, to match a typical roll of carpet (measurements in the American carpet and lumber industries have not converted to metric units, and are expressed in feet and inches; those standard units are used in this application, and can be converted to metric units by the well-known conversion factors, 1 inch=2.54 cm, and 1 foot=0.305 meters; accordingly, carpet rolls that are 12 feet wide are about 3.66 meters wide).

In most systems observed by the Inventors to date, four cross-lapper machines have been used, to allow the conveyor system to move forward at a reasonable and economical speed; if only three cross-lapper systems are used, the conveyor must move more slowly, to obtain uniform coverage by the three ribbons.

4. By the time all of the cross-lapping machines have deposited their thick ribbons of combed fibers on top of the conveyor, the pile of loose and fluffy fibers is roughly 12 to 15 inches (about 30 to 40 cm) thick, and it covers nearly the entire 13-foot width of the conveyor.

5. This thick and fluffy layer of fibers is then compressed, by rollers, to a mat which is about ½″ thick (about 1.2 cm).

6. The compressed mat is then run through a needle-punch machine. In this machine, steel plates that extend across the entire width of the mat hold thousands of long needles, which point downward. These plates, and their needles, are hammered against the mat about 5 times per second, as the mat is slowly pulled through the punching zone. Each needle has a dozen or so nicks or barbs along the surface of its shaft, and each nick or barb can catch fiber strands and pull them downward or upward through the mat.

As a result of the cross-lapping operation, most of the fibers in the mat are laid down horizontally, on top of the conveyor. However, during the needle-punching operation, thousands of fibers per square yard are yanked vertically, both downward and upward, into and through the mat. These vertical fibers hold the mat together, in a fairly tight and cohesive but flexible manner, without requiring any chemical adhesives.

As a result, a typical mat which emerges from a needle-punch machine resembles an extra-thick blanket, containing hundreds of thousands (or even millions) of short but densely intertwined fiber strands per square yard. Depending on how thickly the fiber ribbons were laid down on top of the conveyor system by the cross-lappers, needle-punched mats can be made having thicknesses that range from about ¼ inch up to about ¾ inch.

As the mat emerges from the needle-punching machine, the side edges (which tend to be somewhat ragged) are cut off, usually by a rotating knife blade that interacts with an anvil in a manner comparable to scissors. This trimming operation will form side edges that are even, square, and blunt. Any number of these types of blades can be used, to create mats ranging from about 2 feet wide, up to 12 feet wide.

A mat which is 6 or 12 feet wide is usually rolled onto a heavy cardboard or plastic cylindrical spool, which typically holds a 50-foot length. When a spool is full, a travelling knife blade makes a transverse cut, across the width of the mat. The newly-cut end of the roll is taped or wrapped up, and the roll is sent to inventory, while an empty spool cylinder is moved into place, to begin receiving the next length of needle-punched mat. These rolls are used most commonly for carpet installations.

Mats that are narrower than 6 feet wide are usually cut in smaller lengths, to form rectangles rather than rolls. These rectangles typically range from about 2 to 4 feet in width, and about 2 to 4 feet in length. They usually are stacked flat, to form bundles (or bales, etc.). A typical bundle usually contains about 20 to about 50 mats, all having the same rectangular dimensions, held together by tape, cords, straps, plastic film, or any other suitable tensile material. These mats are used mainly in the automotive industry, since they are inexpensive but can provide effective thermal and noise insulation, in car trunks and various other locations.

Needle-punched mats have been available for many years. They have excellent durability; even after years of heavy foot traffic, they will not flatten significantly, unlike foam or rubberized carpet pads. In addition, they provide very good thermal insulation and sound-deadening effects. Therefore, needle-punched mats that are stored and shipped in rolls are usually installed beneath carpets, in commercial locations, such as stores, offices, restaurants, and theaters. However, they are not popular for carpet installations in homes, due to their inability to provide the type of springy, bouncy, young-and-new feel that appeals to homeowners buying a new carpet. Therefore, since most carpets are installed in homes rather than commercial establishments, there is not a large demand for needle-punched mats made from shredded carpet segments.

Manufacture of Sheetwood Substitutes Using Needle-Punched Mats

Because of the thickness and density of needle-punched mats, no one prior to Bacon et al (PCT application WO 01/76869) was able to create effective and practical methods for using chemical adhesives to convert needle-punched mats into consistent and reliable substitutes for plywood or other sheetwood materials.

The most severe problems that were encountered in prior efforts (most of which were never described in any patents or other publications, because they did not succeed) was that, prior to the methods described in PCT application WO 01/76869, it was extremely difficult and not commercially and economically feasible to obtain the level of consistency, evenness, and uniformity that was necessary to provide a genuinely useful and desirable sheetwood substitute. Even a small irregular patch or “seam” in the penetration, density, consistency, or other traits of an adhesive that has been forced into a dense fibrous mat will render a large sheet of wood-like material severely defective, and unable to compete, economically and commercially, against materials such as standard plywood or oriented-strand board.

However, through extensive testing, Bacon et al figured out three different methods to prevent weak spots, seams, and other irregularities from forming, when certain classes of adhesives were embedded in needle-punched mats.

The first method involves the use of chemical adhesives that are created by mixing together two liquids that will release tiny gas bubbles (in a reaction process that is usually called “foaming”, and occasionally called “creaming”) when they chemically react. One example of such a gas-releasing two-component mixture is offered by the “foaming” subcategory of an important class of adhesives that are generally referred to as polyurethane adhesives, or as isocyanate-polyurethane (IC/PU) adhesives. These adhesives are well-known; they are manufactured by several large companies (including BASF and Bayer), and they are sold by numerous smaller companies that can be located through Internet websites such as www.polyurethane.web. Extensive technical information is publicly available on these compounds, and nearly any company that sells these types of adhesives will have one or more technical specialists or sales representatives who can help any purchaser select a particular mixture for any intended use.

In general, polyurethane adhesives are created by mixing a resin with a catalyst. The resin has the general formula HO—X—OH, where X is a variable that represents any organic component containing carbon atoms. Since a hydroxy group (—OH) coupled to a carbon atom creates an alcohol, this resin can be referred to as an alcohol resin, or as a “diol” (double-alcohol) resin, or as a “polyol” resin if 3 or more hydroxy groups are attached to carbons. The catalyst has at least one cyanate group (O═C═N—). To enable polymerization, most catalysts have at least two cyanate groups, which flank another organic group represented by the variable Y in the following formula: O═C═N—Y—N═C═O. When the catalyst reacts with the resin, the result is polyurethane, which has the general structure: 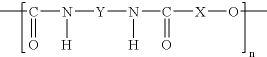
where n is a large number that represents the average number of “monomer” units that were linked together to form polymerized molecules.

Three aspects of the resin and catalyst reagents should be noted:

(1) The “X” variable, in the resin, can be a branched group, with additional hydroxy groups at the tips of some or all of the branches. If a branched resin having multiple hydroxy groups is used, it will create much more complex branched and interlocking molecular matrices than can be achieved by merely linear molecules (these types of resins are often referred to as “polyol” resins, if they contain multiple alcohol groups). In addition, a branched resin can have entirely different types of reactive groups at the tips of some of the branches, thereby allowing that particular resin to undergo additional types of reactions with other types of molecules (such as extremely tight bindings with molecules of nylon, in a nylon fiber composite).

(2) The Y variable, in the cyanate catalyst, can also be a branched group, thereby allowing still more complex branched and interlocking molecular matrices, and offering still more ways that a polyurethane adhesive can be enabled to bind to certain types of substrates, such as nylon fibers. If the Y variable has any type of side chain, then the cyanate catalyst can be referred to as an “isocyanate” resin, since the “iso” prefix in chemistry generally indicates that a chemical group has been affixed to a center carbon atom in a chain that contains 3 or more carbon atoms.

(3) Blends of different resin components, and different catalyst components, can be mixed together. For example, to provide a means to help control and regulate the polymerization reaction, a blend of cyanate catalysts can be used, where most of the catalyst molecules will have two, three, or even more cyanate reactive groups at their ends, but some fraction of the catalyst molecules will have only a single cyanate reactive group. When a catalyst having only a single cyanate reactive group is incorporated into a polymeric chain that is being formed, it will truncate, terminate, and “cap” that end of that polymeric chain. In the same manner, a small percentage of resin molecules having only a single reactive group can be included in the resin mixture, to form similar terminating or “cap” groups at the ends of polymeric chains.

In view of the range of molecular, structural, and binding options they offer, cyanate-polyurethane adhesives are an extremely useful and adaptable class of adhesives. They offer a wide variety of molecular, binding, and performance options and traits, and they have been extensively developed by researchers and companies working in that field of chemistry.

If a suitable foaming mixture is selected and used to convert one or more needle-punched nylon fiber mats into a hardened wood-like sheet product, the cyanate catalyst will be mixed with the alcohol resin, immediately before the mixture is contacted with the fiber mat(s). This can be done by various mechanical means, such as by using a mixing nozzle, mounted on a reciprocating holder that travels back and forth along a rail system that spans the width of a conveyor system, to spread a bead of the cyanate-resin mixture across the surfaces of either or both of two fiber mats, immediately before they are pressed together between large compression rollers at the inlet of a large moving-belt press.

Roughly 10 seconds after the catalyst is mixed with the resin, the liquid mixture will undergo a foaming reaction, which releases gas bubbles that are very effective in driving the liquid, evenly and uniformly, throughout the entire thicknesses of two needle-punched mats that are being pressed against each other inside a press. The resulting polyurethane adhesive will harden sufficiently, within about 8 to 10 minutes, to allow the pressure to be released, and the adhesive will continue to cure and harden slightly over roughly another 24 hours. The pressures required are low enough to allow continuous processing inside a “moving belt” machine, rather than requiring heavy molds or presses that must use “batch processing” to make only 1 sheet at a time. In addition, the chemical reaction that forms the polyurethane adhesive is exothermic, and releases enough energy to minimize or eliminate any need to add additional heat to drive the reaction.

The second method discovered by Bacon et al involves the use of polypropylene, which is widely used in carpet backing layers. Many previous carpet recycling efforts (including efforts to extrude melted nylon into planks, for park benches and similar uses, and efforts to depolymerize nylon, to recover the caprolactam monomers used to manufacture nylon) had gone to great lengths, in an effort to remove as much polypropylene as possible from the nylon fibers, in order to make the recovered nylon as pure as possible. Bacon et al took the opposite approach; instead of trying to purify the nylon fibers, they looked for ways to leave in the polypropylene impurities and put them to good use.

Nylon is a polyamide compound; it contains nitrogen, it is relatively expensive, and the versions used to make carpet fibers (usually called nylon-6 and nylon-6,6) generally have melting temperatures in the range of about 570° Fahrenheit. By contrast, polypropylene is a polyolefin compound; it contains no nitrogen, it is substantially less expensive than nylon, and the versions used in carpet backing layers generally have melting temperatures of only about 330° Fahrenheit. Therefore, polypropylene belongs to a category of plastics that are often called “low melt” plastics.

Instead of trying to remove the polypropylene from a yarn mass obtained by shredding carpets, Bacon et al developed ways to add even more polypropylene, until enough polypropylene was present to make it a useful adhesive, when a needle-punched mat containing sufficient polypropylene is heated to temperatures that will melt the polypropylene, but not the nylon. Their methods of polypropylene addition use either or both of two approaches. One method involves blending polypropylene fibers with the nylon fibers, upstream of the combing operation that created the wide ribbons of fluffy fibers that were cross-lapped onto the conveyor system, as described above. This method can be used to distribute, disseminate, and embed any desired quantity or ratio of polypropylene throughout the entire mass and thickness of fibers that are being laid on top of a conveyor system by cross-lapper machines. The second method involves feeding only polypropylene fibers to the final cross-lapping machine, in a series of cross-lapping machines that are laying their wide ribbons on top of a large conveyor. This method can be used to create a surface “skin” layer of polypropylene, on top of a needle-punched mat containing mostly nylon fibers beneath the skin layer.

The third method that has been identified by Bacon et al, to ensure consistent, uniform, and reliable dispersion of adhesive chemicals throughout the entire area and thickness of a sheetwood material made from needle-punched fiber mats, involves the use of heat-activated (which roughly translates into “meltable”) adhesives that are stored and handled in granular, flake, powdered, or other particulate form. These types of particulate adhesives can be distributed (or disseminated, embedded, etc.) in a fairly even manner, throughout the entire thickness of a fiber mat while it is being laid down by cross-lapper machines on a conveyor system. This can be accomplished by mounting two or more “shaker trays” or similar distributing devices above the conveyor system, in locations positioned between adjacent sets of rails that support the travelling cross-lapper heads. While the system is in operation, the shaker trays are provided with a steady supply of adhesive particulates, using any suitable delivery mechanism. The jostling, vibrating, or other motion of the trays will cause the particulates to steadily and gradually fall out of the tray, in a manner that causes them to be sprinkled in a fairly even manner across the fiber mat which is being formed on top of the conveyor system. Since the fibers are being laid across the conveyor in a fluffy and uncompressed form, settling of the adhesive particulates throughout the loose matrix of fibers will occur, in a manner that will help disperse and distribute the layers of particulate adhesives in a more even and consistent manner, rather than creating sharply-delineated alternating layers of fibers and adhesives.

Using these methods, along with various enhancements that are obvious to those skilled in the art, synthetic sheetwood substitutes containing nylon or other fibers can be manufactured from needle-punched fiber mats (or from air-laid, bat-formed, or other types of fiber mats, as mentioned above).

Because sheetwood materials that will be used for roofing purposes need to be waterproof, any fibers used to manufacture roofing materials using the methods disclosed herein generally should be limited to hydrophobic synthetic materials (such as fibers obtained from carpets made with nylon tufting materials). Any fibers that are hydrophilic (including natural fibers such as cotton and wool, and synthetic fibers such as polyesters) generally should be avoided, in making roofing materials.

It also should be noted that any mixture or blend of nylon fibers made from either nylon-6 or nylon-6,6 can be used as disclosed herein, mixed together in any ratio. Despite their use of the same digit, those two different classes of nylon have substantially different chemical structures. These chemical differences created major problems, in prior art recycling processes that were designed to either: (i) melt and extrude recycled nylon, in a form such as a plank for a park bench, or (ii) chemically break down nylon, to convert it back into its constituent monomers. By contrast, in needle-punched mats used to create sheetwood materials (as disclosed in PCT application WO 01/76869) or to create synthetic roofing materials as disclosed herein, the chemical differences between nylon-6 and nylon-6,6 do not pose any significant problems. Any blend with any ratio of nylon-6 and nylon-6,6 fibers can be used, without requiring any sorting or separating steps.

Flexible Materials, and Plate-Like Materials

As alternative to the sheetwood substitutes disclosed above, which closely resemble plywood in terms of their stiffness and ability to be sawed, drilled, nailed, and otherwise handled, it should also be noted that two other categories of materials also can be formed, by using different types of adhesives in conjunction with needle-punched fiber mats.

One of these categories comprises a flexible layer that can be stored on rolls, in a manner comparable to linoleum or other kitchen floor coverings. This type of material can be created, quite economically, by using heat and pressure to compress a single layer of needle-punched fiber mat that contains an uppermost layer of pure or enriched polypropylene fibers (which can be deposited by the last cross-lapper machine, in a series of cross-lappers). The top layer of polypropylene, which will melt at a temperature of about 350° F., will provide an outer surface that has a somewhat shiny and smooth “glazed” appearance and texture. Since a layer of this type of flexible material, if created from a needle-punched mat having a thickness of about ½ inch or less, will have a stiffness and texture that are comparable to full-grain leather, the outer surface can be regarded as comparable to the smooth surface of a piece of “tanned” leather).

Still other classes of materials, referred to herein as “plate” materials, can be made by using other types of adhesives to impregnate a needle-punched, air-laid, bat-formed, or other type of fiber mat. Because of several factors, which include (i) the high cost and weight of chemical adhesives, compared to fibers, and (ii) the difficulty of forcing liquids to permeate evenly and consistently throughout a long, wide, thick and dense mat, these types of plate materials generally should be limited in thickness, to about ⅜ inch or less. However, by using selected types of adhesives (including various types of resins) that can provide higher levels of hardness (including levels that can approach the hardness of ceramics, if desired), these types of fiber-reinforced plate materials can be used to provide exceptionally hard, strong, and waterproof layers, if desired.

Shortcomings in Prior Art Shingles

Since this invention relates to the use of nylon fiber composites in manufacturing roofing materials, a number of shortcomings, problems, and limitations that are inherent in currently available shingles should be noted and recognized.

This discussion focuses on low-cost shingles that are widely used as roofing materials, on homes and other conventional buildings. Certain types of more expensive materials (including spray-on urethane coatings, etc.) can be used to provide protective coatings on the roofs of specialized buildings, such as manufacturing facilities where even small amounts of water leakage or mold growth could cause very serious problems. However, these types of specialized coating materials generally are too expensive to justify their use on homes and other conventional buildings.

In addition, most such high-tech materials do not provide both: (i) an inexpensive yet strong structural material that can be handled and treated like wood, and that will allow sawing, hammering, and other rough treatment, and (ii) an optimal coating surface that can withstand rain, snow, and all-day sunlight for decades, without leaking. Instead, with most types of high-tech materials, one type of material must be used to provide the desired structural support, and another type of material must be used to provide an outer coating that is waterproof and UV-resistant.

The types of shingles that are commonly used to provide the uppermost roofing layers on most types of homes and other buildings can generally be divided into two major categories, comprising wood shingles, and non-wood shingles.

Wooden shingles usually are nailed to a sheet of plywood or oriented strand board (OSB), which provide structural support for the shingles, and which in turn are nailed to spaced supports (usually rafters and ridge beams). A layer of tarpaper or similar heavy “building paper” is usually positioned between the shingles and the plywood or OSB supporting layer, to help keep out water.

Non-wood shingles can be made from a variety of materials. The most widely used category of non-wood shingles are usually referred to as tar, asphalt, or organic shingles. These typically have a dark substrate layer, which generally comprises a fibrous mat or heavy paper, embedded with an organic compound to make the shingles waterproof. This organic compound usually is an inexpensive petroleum derivative, along the general lines of tar or asphalt. The substrate layer is usually coated, on the exposed upper surface, with sand or other gritty material, both to keep layers of these shingles from sticking to each other, and to give homeowners and workers better traction when they must go up on a roof, to reduce the risk that they will slip, fall off the roof, and be seriously injured.

These types of shingles, made with tar or asphalt substrate, are not the only types of non-wood shingles, and other non-wood shingles are made from fiberglass and certain other types of materials. Some people refer to this entire class of shingles (or to certain subclasses of these shingles) as synthetic shingles, composite shingles, or similar terms; however, these terms are not always used consistently, and this entire class of shingles is referred to herein simply as non-wood shingles.

Both wooden and non-wood shingles suffer from serious shortcomings, including the following:

1. Wood will gradually degrade, when it is exposed to alternating winter and summer weather for a span of decades.

2. Wooden shingles are generally hydrophilic, and after a rain or snow, they tend to hold moisture, including moisture that is in prolonged contact with roofing nails, and with any flashings or other roof components made of metal.

3. Most roofing nails are made of steel, rather than brass or other alloys, to achieve the levels of hardness and stiffness required for a hammering operation. Even though the nails are usually galvanized or otherwise coated, that coating layer is often scraped and otherwise damaged and breached, both on top and along the shaft, when a nail is hammered into position. That leaves the underlying steel accessible to water, and vulnerable to eventual rust.

4. For all of the forgoing reasons, wooden shingles that have been nailed to sheets of plywood or OSB eventually will begin leaking. This commonly occurs after about 20 to 30 years.

5. Wooden shingles also are subject to higher risks of catching fire than non-wood shingles or ceramic tiles. This is especially true for roofs more than a few years old, which usually are thoroughly dried and dehydrated within a few years, by summer-long exposures to direct sunlight and high temperatures. Insurance premiums for wood-shingled homes in rural or wooded areas are substantially higher than for non-wood roofs, and many rural communities and counties (especially in drier regions, where fire hazards are greater) have passed laws that flatly prohibit wooden shingles on roofs.

6. Wooden shingles tend to be expensive to install, since they involve hundreds or even thousands of relatively small pieces, each of which needs to be properly positioned and then hammered into place, through the shingle and the underlying layer (this usually is done with a pneumatic nail gun, but many installers still use hammers, especially for touch-up or repair work). However, despite the higher installation costs, most people want shingled roofs on their homes, because of appearances, tastes, and community standards.

Non-wood shingles offer three main advantages over wooden shingles. First, since they do not contain wood, and since the tar-type binder they contain is not highly flammable (it generally falls within a category called “combustible”, which means it can be burned, but only in a closed container that keeps in the heat), and since they are coated with a layer of sand or grit that will not burn, tar shingles pose less risk of catching fire than wood shingles.

Second, since they do not tend to attract and hold water after a rain or snow, the way wood will do, they do not accelerate the rusting of roofing nails, and they generally tend to be better than wood at remaining watertight, even after decades of exposure to rain, snow, and sunlight.

Third, since they can be cut and installed in multi-shingle strips that can be fairly long and wide (sizes of roughly 2 to 3 feet long, and 1 to 2 feet wide, are common), each segment of a tar or asphalt shingle material usually can replace a dozen or more wooden shingles. This makes tar or asphalt shingles easier, faster, and less expensive to install than wood shingles.

However, tar shingles also suffer from serious shortcomings. Many people do not regard these types of shingles as being as attractive as wood shingles, especially in suburban areas where home values are high. Also, tar or asphalt shingles, and the steel nails that are used to install them on a roof, will eventually degrade and deteriorate, leading to leakage.

In addition, tar or asphalt shingles tend to become very hot during the summer months, and they end up transferring large amounts of heat into the roofs and attics of homes, during hot months, when that extra heat is highly unwanted, and leads to substantially higher air conditioning expenses. This heat transfer problem is aggravated by the fact that tar or asphalt substrates can become semi-melted, softened, and sticky, at the high temperatures that are often reached inside the substrate layers, during a cloudless day in July or August. When the substrate layer of a tar or asphalt shingle becomes hot enough to become softened and sticky, it creates a close and adhering contact layer, between the bottom of the shingle, and the top of the plywood or OSB sheet that supports the shingle (this problem occurs even when a tarpaper or “building paper” sheet is placed between the shingles and the supporting sheets). The resulting interface leads to the transfer of even more unwanted heat into the attic or roofing layer, in a manner that leads to substantial increases in air conditioning costs.

For all of these reasons, there remains a need for improved roofing materials of the type disclosed herein.

Accordingly, one object of this invention is to disclose synthetic roofing materials that contain nylon fibers as a major constituent, manufactured in sheet forms that can be installed at lower costs than required for wood shingle.

Another object of this invention is to disclose synthetic roofing materials that contain nylon fibers, that can be manufactured in sheets that are embossed, molded, or otherwise treated in a manner that creates an appearance that emulates roofing shingles or tiles.

Another object of this invention is to disclose synthetic roofing materials that contain nylon fibers, that have substantially lower risks of catching fire than wooden roofing materials.

Another object of this invention is to disclose synthetic roofing materials that contain nylon fibers, that have been treated in a way that renders them totally waterproof and highly resistant to ultraviolet damage caused by prolonged exposure to sunlight.

Another object of this invention is to disclose synthetic roofing materials that contain nylon fibers, that can reduce heating and air-conditioning costs by providing superior thermal insulation in the outer surface layer(s) of a roof.

Another object of this invention is to disclose synthetic roofing materials made from nylon fiber composites and manufactured in sheet form having an embossed or molded surface that resembles a shingled surface, but which can be nailed or stapled directly to spaced beams, to replace both a layer of shingles, and an underlying layer of plywood or OSB to which shingles would normally be attached.

These and other objects of the invention will become more apparent through the following summary, drawings, and detailed description.

### SUMMARY OF THE INVENTION

This invention relates to synthetic composite materials that contain nylon fibers, and that are designed to be installed on a roof to provide a substitute for shingles or roofing tiles. These composite materials can be provided with an embossed or molded waterproof surface having a shape and appearance that emulates a shingled or tiled surface on a roof. In one embodiment, these materials can be relatively thin, and designed to rest on supporting sheets of plywood or oriented strand board (OSB) that have been nailed to rafters. In an alternate embodiment, these materials can be manufactured in sheets with sufficient thickness, stiffness, and strength to allow them to be nailed directly to rafters, thereby eliminating the need for a supporting layer of plywood or OSB. In a third embodiment, these materials can be molded or embossed to emulate Spanish tiles, or to provide enhanced drainage or other useful traits. For improved waterproofing, the lower edge of each segment can be provided with an overhang that will overlap the upper edge of an adjacent sheet on the next lower horizontal row, to provide overlapping material at each juncture between these composite segments.

These materials can be coated or embedded with specialized chemicals, to provide increased resistance to water, fire, and ultraviolet damage. They provide excellent thermal insulation, and can reduce heating and air conditioning costs. The nylon fibers in these materials can be virgin fibers, or they can be obtained by recycling discarded carpet segments, with any combination of nylon-6 and nylon-6,6 fibers. A preferred manufacturing process uses needle-punched fiber mats; however, air-laid or bat-formed fiber mats can also be used.

### BRIEF DESCRIPTION OF THE DRAWINGS

FIG. 1 depicts a segment of a nylon fiber composite material that is about ¾ inch in maximum thickness, with an embossed upper surface having a shingled appearance. This segment of material can be nailed directly to rafters, to provide a layer of waterproof synthetic material that will replace both an outer layer of shingles, and a layer of plywood or OSB that normally would support a layer of shingles.

FIG. 2 depicts a roll of waterproof nylon fiber composite material, with an embossed upper surface having a shingled appearance that includes strips of dark fibers to give the shadow lines an enhanced appearance.

FIG. 3 depicts a segment of waterproof nylon fiber composite material, having a molded shape and thickness and an embossed surface that resemble Spanish tiles.

### DETAILED DESCRIPTION

As briefly summarized above, this invention relates to roofing materials made of composite materials that contain synthetic fibers, such as nylon fibers. If desired, such fibers can be obtained economically from sources such as discarded carpet segments (either as “post-industrial” waste that was never installed or walked on, or as “post-consumer” waste that was installed on a floor and subsequently removed). Alternately, because of the high levels of utility, durability, and value that can be provided by the roofing products disclosed herein, virgin fibers can be purchased and used if desired, either alone, or mixed with recycled fibers.

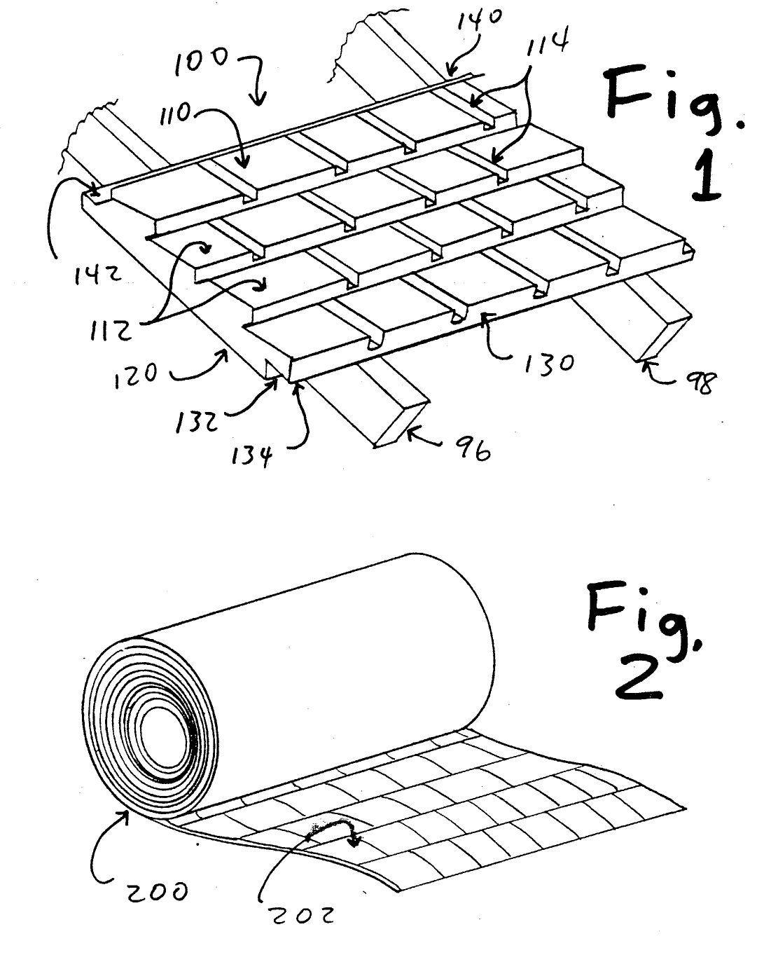

FIG. 1 illustrates a segment of roofing material 100 that can substitute for both (i) an outer layer of shingles, and (ii) an underlying structural supporting sheet, normally made of plywood or OSB. Roofing segment 100 is shown resting on two rafters 96 and 98, with conventional 15 to 18 inch spacing. For clarity of illustration, segment 100 is shown in a reduced size; most such segments will have lengths and widths that are comparable to standard-sized plywood sheets, or even larger if desired.

These segments are designed to provide sufficient thickness, stiffness, and strength to enable these materials to form a rooftop surface that is strong enough, when affixed directly to rafters having conventional 15 to 18 inch spacing, to support normal foot traffic (such as, for example, roofing or construction workers who may weigh up to about 250 pounds, or a homeowner who has gone on top of the roof to clear off leaves or branches, to clean out his gutters, or to inspect or repair some part of his roof).

This type of normal foot traffic, on the rooftop, can be supported by segments of nylon composite materials having a thickness of about ½″ or greater, without requiring installation of any additional structural layers or other material on the rafters, and without requiring anyone on the rooftop to take -any extra care to step only in certain locations. Based on tests done to date, it is likely that this degree of structural support can be provided, with a fully adequate margin of safety that will endure for decades despite daily exposure to weather and direct sunlight, by materials that are less than ½ inch thick.

However, due to the resilience and “springy” response of these fibrous composite materials when subjected to heavy loads, roofing segments made from sheets that are ½ inch thick or less may yield in a manner that is likely to generate anxiety and concern, in a homeowner or worker who is walking across this type of surface supported by spaced rafters. Accordingly, to provide a level of stiffness and strength that will generally be regarded as comforting and reassuring to a typical homeowner who is not familiar with these fiber composites, it is generally believed that such materials, if designed to completely displace a supporting layer of plywood or OSB as well as a layer of shingles, should be at least about ½ inch in thickness, and preferably should be about ⅝ or ¾ inch in thickness, prior to an embossing step.

Roofing segment 100 has an embossed or molded upper surface 110, which has small plateau segments 112 alternating with grooves or troughs 114. The alternating pattern of small plateau segments 112 and grooves 114 is designed to emulate the appearance of a surface generated by wooden shingles, when nailed with conventional spacing to a roof.

As used herein, the terms “molding” and “embossing” are distinct in the following respect. “Embossing” includes any procedure that imparts a controlled and desired non-planar shape or texture to a surface of a material, without substantially altering the bottom surface and/or “dominant plane” of the material. In a layer of material which has a flat bottom surface, embossing the top surface will not alter the flat bottom surface; or, if both sides of a generally planar material are embossed, then the “dominant plane” of the layer will remain flat. Accordingly, embossing is well-suited for creating a layer of roofing material that has a shingled surface on the top, and a flat bottom that can be slid across spaced rafters without “grabbing” or catching on the rafters, so it can be positioned properly and easily before it is nailed or stapled to the rafters.

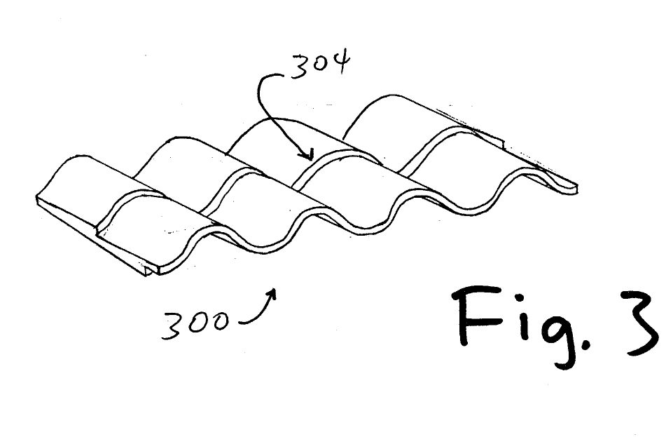

By contrast, a molding operation, as that term is used herein, creates a substantial change in the dominant plane and/or bottom surface of the molded material. Accordingly, an operation that converts a flat layer into a layer that has a rounded, wavy, rippled, or other non-planar shape (such as the Spanish tile structure, illustrated in FIG. 3) would be called a molding operation. In general, it is easier to affix a molded shape to flat sheets of material, than to spaced rafters that may have variations in their spacing.

In general, molding requires a mold cavity of some sort, where opposing “main faces” of the cavity should work together to help impart the desired overall shape to the final product that is being molded. However, it should be recognized that a mold cavity does not always need to be enclosed, and can be provided by other means, such as a moving belt press.

By contrast, an embossing operation can use any of several types of machines. As one example, a sheet or segment of pre-formed material that is supported by a flat conveyor system can be passed through or beneath a machine that is typically called a rolling press, cylinder press, or drum press. In this type of machine, a rotating drum or cylinder having a non-planar surface texture or shape (usually made of a very strong metal alloy that can readily transfer heat into the material being embossed) is pressed into the surface of the material that passes through the press. If desired, the material that is being embossed can be heated and/or chemically treated, prior to and/or during the embossing step, if such heating or chemical treatment will increase its ability to permanently assume and adopt the embossed surface texture for shape.

Alternately, a sheet of segment of pre-formed material can be passed through a “moving-belt” press or other machine, in which a compression plate having an irregular surface shape or texture is pressed into the surface of the material that is being embossed. Unlike a rolling press, a moving-belt press allows the machine's embossing surface to remain pressed into the surface of the material being treated for any desired span of time (which will be determined by the length of the machine, and by the speed at which it is run). An extended compression period (also called “dwell time” or similar terms) can ensure that the surface of a treated material will permanently assume and adopt the embossed shape or texture.

If desired, an embossing surface can be used during the same manufacturing step that uses a chemical adhesive (such as an alcohol-cyanate mixture, a heat-activated particulate adhesive, or meltable polypropylene fibers) to convert a flexible fiber mat into a hardened wood-like material. For example, if a moving belt press is used to carry out the manufacturing step in which a chemical adhesive is being cured, to convert a needle-punched fiber mat into a hardened material comparable to plywood, then a specialized belt with a non-planar embossing surface can be used in that machine, to carry out the embossing step during the same procedure.

However, if the material formed by the adhesive curing and hardening step will subsequently need to be surface-treated, such as by sanding to remove surplus dried adhesive from one or more outer surfaces, it may not be practical to carry out the embossing step during the adhesive curing and hardening step.

In a preferred embodiment, the bottom surface 120 of roofing segment 100 is flat and planar, rather than grooved or embossed, so it can be installed quickly and easily on top of conventional rafters, without requiring any particular alignment with the rafters. Accordingly, if the bottom surface is planar and can be slid across the surfaces of rafters, segment 100 can be positioned properly by lowering it onto a set of rafters in an approximate location, then sliding it downward and horizontally manner until its lower and side edges press firmly against the edges of adjacent segments that already have been installed on the roof (as will be recognized by any competent roofer, the lowest row of segments can be installed by sawing off the overhangs from the lower edges of those segments, and placing each segment at a suitable location, preferably extending roughly ½ to 1 inch beyond the edge of the roof frame, facing board, or other supporting component that the lower edge of segment 100 will rest upon).

After a segment has been properly positioned, it is secured to the rafters (and to a facing board, crown beam, or other roof component, when appropriate) by nails, staples, or other suitable means. If desired, segment 100 can be secured to the rafters by means that can include adhesive, placed on the upper surfaces of the rafters before segment 100 is laid on top of the rafters.

The lower edge 130 of segment 100 is provided with a milled or embossed indentation 132 on its underside, which will provide a lip or overhang 134. The upper edge 140 of segment 100 is also provided with a milled or embossed groove 142, on its upper surface.

Sheets of this type of roofing material can be installed in a conventional manner that is familiar to all roofers, starting at the lower edge of the roof and working upward, installing segments in successively higher horizontal rows until the crown beam or other structure at the highest part of the roof is reached. When successively higher rows of roofing segments 100 are installed in this manner, the lip or overhang 134 on each higher row will fit, in an accommodating manner, on top of groove 142 on the adjacent lower row. This will provide overlapping strips of waterproof roofing material along each juncture, between adjacent horizontal rows of segments. These overlapping strips will help ensure that rainwater or melting snow will run down the surface of the roof, rather than seeping into the building.

If desired, the left and right side edges of each segment also can be provided with accommodating lips and grooves, to create overlapping strips along all side-edge junctures between adjacent segments, as well.

All junctures between adjacent segments should be sealed, by applying a durable waterproof sealing compound (such as silicone rubber, as just one example) to the seam between two adjacent rows of roofing segments.

Thinner Roofing Materials

As indicated above, this invention discloses thinner classes of roofing materials that will replace only an outer layer of shingles, without replacing the underlying supporting sheets made of plywood or OSB (or waterproof nylon fiber composites, as disclosed PCT application WO 01/76869).

These types of relatively thin roofing materials can be packaged and shipped as rectangular bundles or bales (which can be loaded onto pallets, for shipping and handling).

Alternately, these types of thin roofing materials can be stored and shipped on rolls, such as roll 200, shown in FIG. 2. These rolls can be from about 4 to about 12 feet wide, and can contain continuous lengths, ranging from about 20 to about 150 feet, depending on the thickness of the roofing material on a particular roll. One surface 202 of the material on roll 200 can be embossed and/or dyed, blended, or otherwise pigmented, to provide an outer surface (after installation) that will resemble a shingled roof. Preferably, thinner roofing materials that are shipped in rolls or bales should be designed to resemble the surfaces of tar or asphalt shingles, which are relatively thin, rather than attempting to emulate the appearance of substantially thicker wooden shingles.

Any suitable method can be used to install these materials. As one example, a large roll on a wheeled dolly, truck, or other rollable device can be rolled into position, next to a building that is being built or repaired. The leading edge of the rolled material is then handed up to workers on top of the building, who will pull and maneuver it into position and then secure the top edges and the sides, such as by using nails or large staples. The lower edge will then be cut, to align it properly with a structural support, and it will then be secured. The large roll can then be wheeled to the next location, and the process will be repeated until the entire roof of the building has been properly covered.

Molded Materials; Tile Emulation

As another alternative type of roofing material that can be made from nylon fiber composites as disclosed herein, the fiber composite materials disclosed herein can be used to manufacture molded roofing materials, that are designed to emulate Spanish tiles. An example is shown by segment 300, shown in FIG. 3. This approach can be used to create roof surfaces that are stronger and more durable than Spanish tiles made of clay or other ceramics, which can be cracked and broken.

For illustration purposes, segment 300 as shown in FIG. 3 emulates two rows of tiles, with each row emulating 4 contiguous (i.e., adjacent and touching) tile segments. If manufactured in a larger sheet, a single segment of molded composite material can emulate a larger number of rows, such as up to about 10 to 20 rows of tiles, depending on the length of each tile segment. Alternately, to provide better and sharper overlapping delineations between tiles, each segment of a molded composite material can emulate a single row of tiles, in a relatively long segment that will contain multiple crests (also called ridges, humps, tops, etc.). While long strips (such as having 15 or more crests) would be faster to install, shorter strips (such as having 4 to 8 crests) would be easier to replace or repair, if the need ever arises.

If desired, this type of molding operation can be carried out using a combination of (i) a single large sheet of fiber mat, to provide the bulk of the material, including the continuous backing, and (ii) additional strips of material that can be laid on top of the large sheet, during the molding operation, to form the lower edges of ridges that will be positioned within the interior of a molded segment. As an example, it may be possible to form a segment having internal ridge 304, shown in FIG. 3, with a lower overall thickness for the entire segment (and therefore with lower total manufacturing costs), by laying a secondary strip of fiber mat across the width of the segment that is being molded, at the location where the lower edge of the secondary strip will form ridge 304. If desired, this type of strip which provides additional thickness can be laid on top of a fiber mat immediately before a short and gentle needle-punching, sewing, or other securing operation is carried out, to ensure that the secondary strip will remain precisely positioned on top of the main sheet, during the molding operation.

Other types of molded roofing materials also can be created, to provide enhanced drainage or other useful traits, and to cover corners, angles, gable crests, drainage troughs, or other non-planar shapes that commonly exist on roofs. These types of materials can be made in any desired size and thickness (such as in stackable segments that are, for example, 2 feet wide and 3 feet long), so that one or two workers can carry a 50 to 100 pound bundle, either alone or on a small and lightweight pallet, without requiring power equipment for hoisting a bundle up onto a roof.

If desired, the exposed upper surface of any of the embossed or molded nylon composite materials disclosed herein can be painted or otherwise pigmented, using any desired mode of application. Methods that can be evaluated for such use include, for example: (i) spraying a completed article with paint or ink; (ii) using rollers or brushes to apply ink or paint, followed by air jets to create smoothed or shaded appearances; and, (iii) embedding strips of dark fibers, from dark carpets, into selected rows or other locations, during the operation that is used to create a needle-punched or other fiber mat. For example, ribbons of dark material can be laid on top of a compressed fiber mat, using alignment devices that will lay down the dark ribbons immediately before the mat enters a needle-punching zone, since the needle-punching operation will then immediately affix the dark strips to the mat in a non-movable location.

These fiber-composite materials also can be provided with any desired type of surface layer, to provide enhanced performance and endurance. Since needle-punching, adhesive-curing, and embossing operations would all be likely to damage or jeopardize any such surface coating, and since it may be necessary to sand or otherwise treat a hardened surface shortly after an adhesive curing operation, it is generally anticipated that the best results are likely to be provided if a waterproof and UV-resistant coating layer is applied to the outer surface of a segment or roll of roofing material, after the adhesive has been cured, and after as many sanding, sawing, embossing, or other surface-treating or material-handling operation(s) have been completed as practicable. Accordingly, when an appropriate time arrives to coat a segment or roll of material with an outer “skin” that will increase UV resistance, waterproofing, or other desired traits, the skin layer can be deposited on top of the composite material by any suitable means, such as by spraying, painted, and by film-depositing methods (which can include methods that use heat or radiation to cause a film to shrink).

Similarly, a gritty, “high-tack” or other coating material that is designed to ensure good traction and safety on a rooftop, even in wet weather, can also be applied.

Any or all of these types of coating can also be applied, by installers, after a roofing layer as disclosed herein has been completely assembled. This would be comparable to water-sealing a deck, after construction of the deck has been completed. It could use a paint-sprayer, or rollers or large brushes on extension handles, etc.

If desired, the composite materials disclosed herein can be affixed to structural supports, using connector devices or compounds that cannot rust. Such devices can include, for example, nails, staples, or anchors made of stainless steel or a non-rusting alloy, a hard polymer or graphite, or comparable materials. Suitable affixing compounds also include strong adhesives, and it is believed that some types of adhesives, including non-foaming isocyanate-polyurethane epoxy compounds, can bond to these fiber composites by creating chemical bonds as strong as those found in the composites themselves.

The exposed portions of any nails, staples, or other connectors that are used (regardless of whether they are rustable) can be covered and sealed in a watertight manner, using a strong and durable waterproof adhesive, such as a silicone rubber sealant. Similarly, a durable waterproof sealant, caulk, or other adhesive material can be used to seal any seams or other gaps between adjacent sheets or segments of roofing materials, or between a sheet or segment of material and any structural object on or near a roof.

Since higher grades of the fiber composite materials disclosed herein will not rot and degrade in a manner comparable to wood, if a leak ever develops in a roof made of these materials, it may be possible to completely repair the damage without having to remove any materials from the roof. In some cases, this might be done by a spraying, caulking, or similar operation, while in other cases, it might be done by installing an additional layer of a relatively thin fiber composite material on top of whatever is already there, and then sealing the added layer around the edges, using a liquid adhesive that will harden or cure.

Manufacturing, Handling, and Transporting Composite Materials

Several comments should also be provided, concerning the manufacture. handling, and transport of the nylon fiber composite roofing materials disclosed herein.

First, it should be recognized that fibers of nylon-6 and nylon-6,6 (these are the two main types of nylon fibers used in carpets) can be mixed together, in any desired ratio, in the composite materials discussed herein. Despite their common use of the number 6, those are two very different chemical compounds, and those two classes of nylon fibers must be separated, if depolymerization or similar chemical treatment will be carried out, or if the resulting product will be heated and extruded (which is a preferred method for making planks and other relatively narrow materials from recycled nylon).

Other types of synthetic or other fibers can also be evaluated for potential use, in one or more types of roofing materials as disclosed herein. However, it should be kept in mind that the outer exposed layer of any roofing material should be waterproof, and underlying layers preferably should also be waterproof, or at least highly water resistant, in case any minor leaks eventually develop. Therefore, synthetic fibers that are hydrophobic generally offer better candidates for such evaluation and use. By contrast, fibers from water-washable textiles (such as cotton), and other types of hydrophilic fibers, fibers that will form dust or other particulates when shredded, and fibers that tend to be rapidly degraded by exposure to direct sunlight, generally should be avoided, for use in fiber-composite roofing materials.

As briefly summarized in the Background section, and as described in more detail in PCT patent application PCT/US01/11895 (published as WO 01/76869), one preferred method for making fiber-composite roofing materials includes the following steps: (i) using cross-lapper machines to deposit wide “ribbons” of fibers (such as from shredded carpet segments) on top of a conveyor system, to form a thick and fluffy pile or mat of fibers; (ii) compressing the resulting pile of fluffy material, between rollers; and (iii) subjecting the resulting mat to a needle-punching operation, to pull individual fibers in both upward and downward directions, through the thickness of a horizontal mat.

As mentioned in the Background section, needle-punching will give the resulting mat a higher level of cohesive strength than various other types of fiber mats; such as “air-laid” or “bat-formed” mats. Accordingly, needle-punched fiber mats can generally create fiber composite materials that are likely to have greater strength, flexibility, and durability than can be achieved by using fiber mats formed by air-laying, bat-forming, or other processes.

However, it must be recognized that high levels of strength, flexibility, and durability are not required for all types or grades of roofing material. Therefore, some types and grades of roofing materials can be made from air-laid, bat-formed, or other types of fiber mats, if desired.

When a fiber mat is made by using cross-lapper machines to deposit ribbons of material, transversely, on a moving conveyor system, the width of the resulting mat is limited only by the width (and to some extent the speed) of the conveyor system. Most needle-punching systems in use today, to make carpet underlayers, use conveyor systems that are about 13 feet wide, so that after the uneven side edges are trimmed off, the final mat will be exactly 12 feet wide, to accommodate carpet rolls that are also 12′ wide.

Accordingly, the fiber mats that are manufactured by these types of already-existing needle-punch systems can be used to make sheetwood or rolled roofing materials that have any desirable and practical widths and lengths. While sheets or rolls up to 12 feet in width are possible, it is nevertheless presumed and believed that sheets of roofing materials generally should be limited to about 4 feet by 8 feet, if they are going to be handled by two men working together without support by a ground crew, and that rolls of roofing materials generally should be limited to widths of about 8 feet or less, because of the difficulties and dangers of working on sloping rooftops, where a slip and fall could cause death or a crippling injury.

It should also be noted, however, that relatively long strips of stiff or rolled materials can be manufactured by the same machines and methods disclosed herein, and work crews can be trained to handle these types of sheets in a safe manner. As an example, two workmen standing on the ground could lift up a long strip of material, which is 4, 6, or 8 feet wide, and which is 10 to 20 feet long, in a manner that would allow two workmen standing on top of a building to grab the sheet of material and slide it up onto the roof, for installation. Alternately, a hand-powered or electrical winch system could be provided, which could hoist a pallet or stack of such sheets (containing anywhere from 2 to 25 such sheets) up onto the roof of a house or other building that is being built or repaired. As another alternative, a ground crew could use one or two gripping poles, with stiff shafts and a clamping device at one end of each shaft, to grip the lower edge of a long stiff sheet, to help lift the sheet up onto a sloping roof and then provide support for it while one or two workmen on the roof maneuver it into position and then nail or staple it down securely.

Accordingly, the owner and operator of a press that manufactures these types of sheets and/or rolls of roofing materials, from needle-punched or other fiber mats, can select a preferred manufacturing width, based on technical, economic, and safety factors. If desired, sheets or rolls of fiber mats that are slightly more than 4, 6, 8, or 12 feet wide can be fed into a press, where they will be converted (by polyurethane or other chemical adhesives) into sheets that are either thick and stiff (comparable to plywood), or thin and flexible (comparable to linoleum flooring). The sheets that emerge from the press can be side-trimmed to give them exact 4, 6, 8, or 12 foot widths, and they can be cut into any desired lengths, using a transverse saw that will travel on the conveyor system at exactly the same speed as the emerging material. They can be either stacked on pallets that can be handled by standard forklifts (for thick and stiff sheets, having dimensions such as 4 feet by 8 feet or smaller); or, they can be gathered on rolls (for thin and flexible sheets, having lengths such as 50 or 100 feet per roll) that can be handled by modified forklifts having a single long lifting prong, for handling materials such as carpet rolls. The pallets or rolls can be conveniently loaded onto a truck, railroad car, or other mode of transport, for delivery to a lumber, hardware, or roofing store, a warehouse, or any other suitable facility.

This type of manufacture and handling is generally suitable for large sheets of material, regardless of thickness, and it is well suited for manufacturing structural layers (usually made of plywood or OSB, today) that will be nailed directly to rafters. If desired, structural sheets made from nylon fiber composites can be provided with sufficient thickness and strength to allow a single layer of synthetic fiber composite material to provide both a structural layer, and an embossed outer surface that resembles shingles.

There is not a major demand or need for sheets of wood-like structural materials that are pre-sized to have lengths and widths smaller than 4′×8′. To the extent that any need for smaller sizes exists, a 4′×8′ sheet of roofing material as disclosed herein can simply be sawed down to any desired size or shape, before the piece that has been cut to size is carried up to the top of a building.

However, there is a substantial need for bundles (or bales, etc.) of shingles that are small enough and light enough to be lifted and carried up to a rooftop by one or two workers, without requiring a forklift, power winch, or other power equipment. Therefore, relatively thin shingle material (with embossed and/or pigmented surfaces, and/or with non-linear lower cut edges, if desired, to more closely resemble regular shingles after installation) can be made in any desired size, by steps such as using saws, die-cutting machines, rolling blades that interact with anvils, or other suitable devices to cut larger sheets of materials into smaller segments. These segments generally will have dimensions that will range from about 1 to about 4 feet long, and about 1 to about 3 feet wide, with thicknesses that usually will range from about ⅛ inch up to about ½ inch. They can be stacked and bundled in bales having any desired height and weight, such as in bales weighing from about 40 to about 140 pounds.

Thus, there has been shown and described a new and useful means for creating improved roofing materials and structures, from composite materials that contain nylon fibers. Although this invention has been exemplified for purposes of illustration and description by reference to certain specific embodiments, it will be apparent to those skilled in the art that various modifications, alterations, and equivalents of the illustrated examples are possible. Any such changes which derive directly from the teachings herein, and which do not depart from the spirit and scope of the invention, are deemed to be covered by this invention.

1. An article of manufacture, comprising a segment of composite material that contains nylon fibers and that has at least one embossed surface which has a surface appearance designed to emulate a shingled surface appearance on a roof.

2. The article of manufacture of claim 1, wherein the segment of composite material has sufficient thickness, stiffness, and strength to enable it to support construction workers and homeowners, when affixed directly to spaced rafters without any additional structural material on said rafters.

3. The article of manufacture of claim 1, wherein the segment of composite material has a lower edge that is provided with an overhang component that is designed to create an overlapping strip of roofing material along each juncture between adjacent horizontal rows of segments of composite material, after installation of multiple segments on a rooftop.

4. The article of manufacture of claim 1, wherein the segment of composite material has been fabricated by a process which includes a step of curing a chemical adhesive within a needle-punched fiber mat.

5. The article of manufacture of claim 1, wherein the segment of composite material has been fabricated by a process which includes the step of curing a chemical adhesive within a fiber mat that was manufactured by a process selected from the group consisting of bat-forming and air-laying.

6. The article of manufacture of claim 1, wherein the embossed surface of the segment of composite material has been coated with a layer of material that increases resistance to damage caused by ultraviolet radiation.

8. The article of manufacture of claim 1, wherein the segment of composite material contains a cured adhesive that was formed by mixing together two adhesive components that release gas bubbles after being mixed together.

9. The article of manufacture of claim 1, wherein the segment of composite material contains a cured adhesive that was formed by heating a fiber mat that contained a particulate heat-activated adhesive.

10. An article of manufacture, comprising a segment of composite material that contains nylon fibers and that has at least one embossed surface designed to emulate a shingled rooftop surface.

11. The article of manufacture of claim 10, wherein the segment of composite material has sufficient thickness and strength to enable it to support conventional foot traffic, when affixed directly to conventionally spaced rafters without any additional supporting material on said rafters.

12. The article of manufacture of claim 10, wherein the segment of composite material has a lower edge that is provided with an overhang component that is designed to create an overlapping strip of roofing material along each juncture between adjacent horizontal rows of segments of composite material, after installation of multiple segments on a rooftop.

13. The article of manufacture of claim 10, wherein the embossed surface of the segment of composite material has been coated with a layer of material that increases resistance to damage caused by ultraviolet radiation.

14. The article of manufacture of claim 10, wherein the segment of composite material contains a cured adhesive that was formed by mixing together two adhesive components that release gas bubbles after being mixed together.

15. The article of manufacture of claim 10, wherein the segment of composite material contains a cured adhesive that was formed by heating a fiber mat that contained a particulate heat-activated adhesive.

16. A section of a building roof, comprising a plurality of segments of a composite material that contains nylon fibers and that has at least one embossed surface which has a surface appearance designed to emulate a shingled surface appearance on a roof.

17. The section of a building roof of claim 16, wherein the section was coated, after assembly, with at least one chemical compound that provided increased resistance to ultraviolet radiation.

18. The section of a building roof of claim 16, wherein the section was coated, after assembly, with at least one chemical compound that provided increased resistance to water permeation.

19. An article of manufacture, comprising a segment of composite material that contains nylon fibers and that has a molded shape designed to emulate at least one roofing tile.

20. The article of manufacture of claim 19, wherein the segment of composite material has a molded shape designed to emulate a plurality of roofing tiles in a contiguous row.

21. The article of manufacture of claim 19, wherein the segment of composite material has been fabricated by a process which includes a step of curing a chemical adhesive within a needle-punched fiber mat.

22. The article of manufacture of claim 19, wherein the segment of composite material has been fabricated by a process which includes the step of curing a chemical adhesive within a fiber mat that was manufactured by a process selected from the group consisting of bat-forming and air-laying.

23. The article of manufacture of claim 19, wherein the segment of composite material contains a cured adhesive that was formed by mixing together two adhesive components that release gas bubbles after being mixed together.

24. The article of manufacture of claim 19, wherein the segment of composite material contains a cured adhesive that was formed by heating a fiber mat that contained a particulate heat-activated adhesive.
